(19) United States
(12) Patent Application Publication
(10) Pub. No.: US 2007/0239439 A1
(43) Pub. Date: Oct. 11, 2007

(54) METHOD AND APPARATUS FOR TRAINING F0 AND PAUSE PREDICTION MODEL, METHOD AND APPARATUS FOR F0 AND PAUSE PREDICTION, METHOD AND APPARATUS FOR SPEECH SYNTHESIS

(75) Inventors: Lifu Yi, Don Cheng District (CN); Jie Hao, Dong Cheng District (CN)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/692,392

(22) Filed: Mar. 28, 2007

(30) Foreign Application Priority Data
Apr. 6, 2006 (CN) 200610073145.X

(51) Int. Cl. G10L 19/00

(52) U.S. Cl. 704/219

(57) ABSTRACT

The present invention provides a method and apparatus for training F0 and pause prediction model, method and apparatus for F0 and pause prediction, method and apparatus for speech synthesis. Said method for training an F0 prediction model, comprising: representing F0 with an orthogonal polynomial; for each parameter of the orthogonal polynomial, generating an initial parameter prediction model with a plurality of attributes related to F0 prediction and at least part of possible attribute combinations of said plurality of attributes, in which each of said plurality of attributes and said attribute combinations is included as an item; calculating importance of each said item in said parameter prediction model; deleting the item having the lowest importance calculated; re-generating a parameter prediction model with the remaining items; determining whether said re-generated parameter prediction model is an optimal model; and repeating said step of calculating importance and the steps following said step of calculating importance with the newly re-generated parameter prediction model, if said parameter prediction model is determined as not an optimal model; wherein the orthogonal polynomial and all parameter prediction models of the orthogonal polynomial form the F0 prediction model.

### TECHNICAL FIELD

The invention relates to information processing technology, specifically, to the technology of training F0 and pause prediction models with a computer, the technology of F0 and pause prediction and the technology of speech synthesis.

### TECHNICAL BACKGROUND

F0 prediction is generally divided into two steps. The first step is to represent F0 contour by parameters of a specified intonation model. The second step is to use data-driven methods to predict these parameters from linguistic attributes. Most of the existing representations are too complex and unstable to estimate and predict.

A number of models for F0 prediction have been proposed, for example, Fujisaki and PENTA are two different typical parametric models for F0 representation. Fujisaki model represents F0 contour as the linear combination of long-term and short-term components, i.e. phrase and accent (tone) components. PENTA model is a typical linearly sequenced model and pays more attention on influence of local events to big prosodic units than that in Fujisaki model. Both parametric forms contain an exponent, and exhibit complex behaviors and they are very unstable to solve the parameters.

The Fujisaki model has been described in detail, for example, in the article “Joint Extraction and Prediction of Fujisaki's Intonation Model Parameters”, Pablo Daniel Agüero, Klaus Wimmer and Antonio Bonafonte, In ICSLP 2004, Jeju Island, Korea, 2004.

The PENTA model has been described in detail, for example, in the article “The PENTA model of speech melody: Transmitting multiple communicative functions in parallel”, Xu, Y., in Proceedings of From Sound to Sense: 50+ years of discoveries in speech communication, Cambridge, Mass., C-91-96, 2004, and in the article “F0 generation for speech synthesis using a multi-tier approach”, Sun X., in Proc. ICSLP′02, pp. 2077-2080.

For Pause prediction, current technology only assumes Gaussian distribution for pause, and other distributions are not studied yet. Many statistic models have been proposed for pause prediction, such as CART (Classification And Regression Tree), MBL (Memory Based Learning), and ME (Maximum Entropy Model), wherein CART, MBL and ME are fashionable methods for Chinese TTS (Text-to-Speech system). They assume Gaussian distribution or null special distribution for pause. No specified characteristics of pause are considered on the modeling distribution hypothesis.

The Classification And Regression Tree (CART) has been described in detail, for example, in the article “Intonational Phrase Break Prediction Using Decision Tree and N-Gram Model”, Sun, X. and Applebaum, T. H., in Proceedings Euro speech 2001, Denmark, Vol 1, pp. 537-540.

The Memory Based Learning (MBL) has been described in detail, for example, in the article “Predicting. phrase breaks with Memory-Based Learning”, Bertjan Busser, W. Daelemans, Van den Bosch, in Proceedings 4th. ISCA Tutorial and research Workshop on Speech Synthesis, Perthshire Scotland, 2001.

The Maximum Entropy Model (ME) has been described in detail, for example, in the article “Chinese Prosody Phrase Break Prediction Based on Maximum Entropy Model”, Jian-feng Li, Guo-ping Hu, Wan-ping Zhang, and Ren-hua Wang, In Proceedings ICSLP Oct. 4-8, 2004, Korea, pp. 729-732, and in the article “Sliding Window Smoothing For Maximum Entropy Based Intonational Phrase Prediction In Chinese”, Jian-Feng Li, Guo-Ping Hu, Ren-Hua Wang, and Li-Rong Dai, in Proceeding of ICASSP2005, Philadelphia, Pa., USA, pp. 285-288. All of which are incorporated herein by reference.

Otherwise, both F0 and pause prediction methods use the linguistic attributes and attribute combinations which are guided by existing linguistic knowledge, but not totally data-driven method. Moreover, they pay no attention on the contribution of the speaking rate to their prediction.

However, the traditional methods have following shortcomings:

1) The existing models' coefficients can be computed by the data driven method. But the attributes and attributes combinations are selected manually instead of being selected by data driven method. So these “partially” data driven modeling methods depend on subjective empiricism.

2) Speaking rate is not introduced as an attribute for F0 and pause modeling. But segmental F0 and pause is obviously affected by speaking rate from the existing prosody researches. Thus, speech synthesizer has no choice but to linearly shorten or lengthen the segmental F0 and pause when users need to adjust speaking rate. But in fact, effects of different attributes on segmental F0 and pause differ widely, so it's not reasonable to do linear shortening and lengthening.

### SUMMARY OF THE INVENTION

In order to solve the above problems in the prior art, the present invention provides a method and apparatus for training a F0 prediction model, method and apparatus for F0 prediction, method and apparatus for speech synthesis, and a method and apparatus for training a pause prediction model, method and apparatus for pause prediction, method and apparatus for speech synthesis.

According to one aspect of the invention, there is provided a method for training an F0 prediction model, comprising: representing F0 with an orthogonal polynomial; for each parameter of the orthogonal polynomial, generating an initial parameter prediction model with a plurality of attributes related to F0 prediction and at least part of possible attribute combinations of said plurality of attributes, in which each of said plurality of attributes and said attribute combinations is included as an item; calculating importance of each said item in said parameter prediction model; deleting the item having the lowest importance calculated; re-generating a parameter prediction model with the remaining items; determining whether said re-generated parameter prediction model is an optimal model; and repeating said step of calculating importance and the steps following said step of calculating importance with the newly re-generated parameter prediction model, if said parameter prediction model is determined as not an optimal model; wherein the orthogonal polynomial and all parameter prediction models of the orthogonal polynomial form the F0 prediction model.

According to another aspect of the invention, there is provided a method for F0 prediction, comprising: training an F0 prediction model using the above-mentioned method for training an F0 prediction model; obtaining corresponding values of said plurality of attributes related to F0 prediction; and calculating the F0 based on said F0 prediction model and said corresponding values of said plurality of attributes related to F0 prediction.

According to another aspect of the invention, there is provided a method for speech synthesis, comprising: predicting F0 using the above-mentioned method for F0 prediction; performing speech synthesis based on the F0 predicted.

According to another aspect of the invention, there is provided an apparatus for training an F0 prediction model, comprising: an initial model generator configured to represent F0 with an orthogonal polynomial, and for each parameter of the orthogonal polynomial, generate an initial parameter prediction model with a plurality of attributes related to F0 prediction and at least part of possible attribute combinations of said plurality of attributes, in which each of said plurality of attributes and said attribute combinations is included as an item; an importance calculator configured to calculate importance of each said item in said parameter prediction model; an item deleting unit configured to delete the item having the lowest importance calculated; a model re-generator configured to re-generate a parameter prediction model with the remaining items after the deletion of said item deleting unit; and an optimization determining unit configured to determine whether said parameter prediction model re-generated by said model re-generator is an optimal model; wherein the orthogonal polynomial and all parameter prediction models of the orthogonal polynomial constitute the F0 prediction model.

According to another aspect of the invention, there is provided an apparatus for F0 prediction, comprising: an F0 prediction model that is trained by using the above-mentioned method for training an F0 prediction model; an attribute obtaining unit configured to obtain corresponding values of said plurality of attributes related to F0 prediction; and an F0 calculator configured to calculate the F0 based on said F0 prediction model and said corresponding values of said plurality of attributes related to F0 prediction.

According to another aspect of the invention, there is provided an apparatus for speech synthesis, comprising: the above-mentioned apparatus for F0 prediction; and said apparatus for speech synthesis is configured to perform speech synthesis based on the F0 predicted by said apparatus for F0 prediction.

According to another aspect of the invention, there is provided a method for training a pause probability prediction model, comprising: generating an initial pause probability prediction model with a plurality of attributes related to pause prediction and at least part of possible attribute combinations of said plurality of attributes, in which each of said plurality of attributes and said attribute combinations is included as an item; calculating importance of each said item in said pause probability prediction model; deleting the item having the lowest importance calculated; re-generating a pause probability prediction model with the remaining items; determining whether said re-generated pause probability prediction model is an optimal model; and repeating said step of calculating importance and the steps following said step of calculating importance with the newly re-generated pause probability prediction model, if said pause probability prediction model is determined as not optimal model.

According to another aspect of the invention, there is provided a method for pause prediction, comprising: training a pause probability prediction model using the above-mentioned method for training a pause probability prediction model; obtaining corresponding values of said plurality of attributes related to pause prediction; calculating the pause probability based on said pause probability prediction model and said corresponding values of said plurality of attributes related to pause prediction; and comparing said calculated pause probability with a threshold to obtain the pause.

According to another aspect of the invention, there is provided a method for speech synthesis, comprising: predicting pauses using the above-mentioned method for pause prediction; performing speech synthesis based on the pauses predicted.

According to another aspect of the invention, there is provided an apparatus for training a pause probability prediction model, comprising: an initial model generator configured to generate an initial pause probability prediction model with a plurality of attributes related to pause prediction and at least part of possible attribute combinations of said plurality of attributes, in which each of said plurality of attributes and said attribute combinations is included as an item; an importance calculator configured to calculate importance of each said item in said pause probability prediction model; an item deleting unit configured to delete the item having the lowest importance calculated; a model re-generator configured to re-generate a pause probability prediction model with the remaining items after the deletion of said item deleting unit; and an optimization determining unit configured to determine whether said pause probability prediction model re-generated by said model re-generator is an optimal model.

According to another aspect of the invention, there is provided an apparatus for pause prediction, comprising: a pause probability prediction model that is trained by using the above-mentioned method for training a pause probability prediction model; an attribute obtaining unit configured to obtain corresponding values of said plurality of attributes related to pause prediction; a pause probability calculator configured to calculate the pause probability based on said pause probability prediction model and said corresponding values of said plurality of attributes related to pause prediction; and a comparator configured to compare said calculated pause probability with a threshold to obtain the pause.

According to another aspect of the invention, there is provided an apparatus for speech synthesis, comprising: the above-mentioned apparatus for pause prediction; and said apparatus for speech synthesis is configured to perform speech synthesis based on the pauses predicted.

### BRIEF DESCRIPTION OF THE DRAWINGS

It is believed that the above features, advantages and objectives of the invention will be better understood through the following description of the implementations of the invention in conjunction with the accompany drawings, in which:

FIG.1 is a flowchart of the method for training a F0 prediction model according to one embodiment of the present invention;

FIG.2 is a flowchart of the method for F0 prediction according to one embodiment of the present invention;

FIG.3 is a flowchart of the method for speech synthesis according to one embodiment of the present invention;

FIG.4 is a block diagram of the apparatus for training a F0 prediction model according to one embodiment of the present invention;

FIG.5 is a block diagram of the apparatus for F0 prediction according to one embodiment of the present invention; and

FIG.6 is a block diagram of the apparatus for speech synthesis according to one embodiment of the present invention.

FIG.7 is a flowchart of the method for training a pause probability prediction model according to one embodiment of the present invention;

FIG.8 is a flowchart of the method for pause prediction according to one embodiment of the present invention;

FIG.9 is a flowchart of the method for speech synthesis according to one embodiment of the present invention;

FIG.10 is a block diagram of the apparatus for training a pause probability prediction model according to one embodiment of the present invention;

FIG.11 is a block diagram of the apparatus for pause prediction according to one embodiment of the present invention; and

FIG.12 is a block diagram of the apparatus for speech synthesis according to one embodiment of the present invention.

### DETAILED DESCRIPTION OF THE INVENTION

In order to facilitate the understanding of the following embodiments, firstly we briefly introduce GLM (Generalized Linear Model) model and BIC (Bayes Information Criterion).

GLM model is a generalization of multivariate regression model, while SOP (Sum of Products) is a special case of GLM. The GLM parameter prediction model predicts the parameter \hat{d} from attributes A of speech units by

$${d}_{1} = {\hat{d}}_{i} + {e}_{i} = {h}^{- 1} ( {β}_{0} + {\sum }_{j = 1}^{p} {β}_{j} {f}_{j} ( A ) ) + {e}_{i} \qquad ( 1 )$$

Where h is a link function. In general, it is assumed that the distribution of d is of exponential family. Using different link functions, we can get different exponential distributions of d. GLM can be used as either linear model or non-linear model.

A criterion is needed for comparing the performance of different models. The simpler a model is, the more reliable predict result for outlier data, while the more complex a model is, the more accurate prediction for training data. The BIC criterion is a widely used evaluation criterion, which gives a measurement integrating both the precision and the reliability and is defined by:
BIC=Nlog(SSE/N)+plogN (2)

Where SSE is sum square of prediction errors. The first part of right side of the equation 2 indicates the precision of the model and the second part indicates the penalty for the model complexity. When the number of training sample N is fixed, the more complex the model is, the larger the dimension p is, the more precise the model can predict for training data, and the smaller the SSE is. So the first part will be smaller while the second part will be larger, vice versa. The increase of one part will lead to the decrease of the other part. When the summation of the two parts is the minimum, the model is optimal. BIC may get a good balance between model complexity and database size, this helps to overcome the data sparsity and attributes interaction problem.

Next, a detailed description of the preferred embodiments of the present invention will be given in conjunction with the accompany drawings.

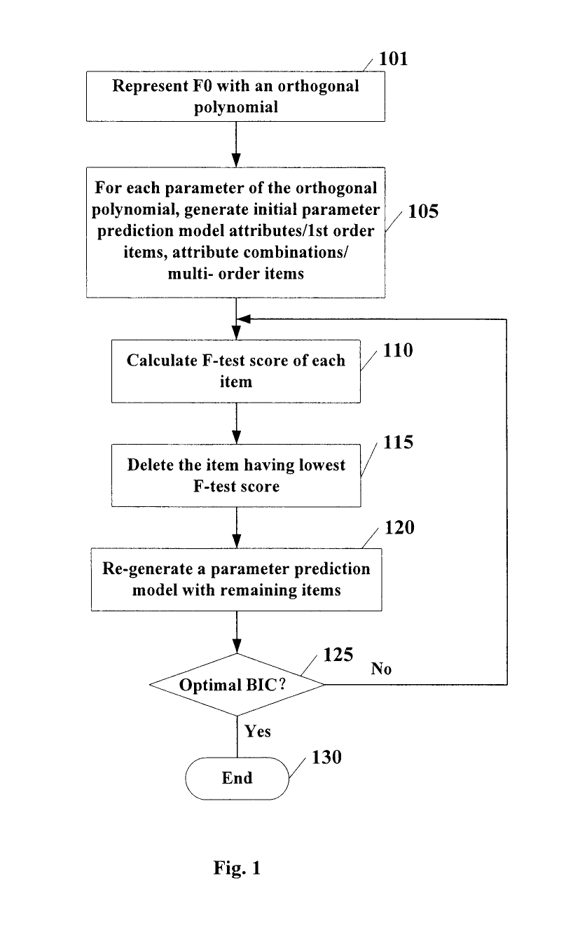

FIG. 1 is the flowchart of the method for training a F0 prediction model according to one embodiment of the present invention. The F0 prediction model trained by the method of this embodiment will be used in the method and apparatus for F0 prediction and the method and apparatus for speech synthesis described later in conjunction with other embodiments.

As shown in FIG. 1, first at Step 101, F0 is represented with an orthogonal polynomial. Specifically, in this embodiment, a second-order (or high-order) Legendre orthogonal polynomial is chosen for the F0 representation. The polynomial also can be considered as approximations of Taylor's expansion of a high-order polynomial, which is described in the article “F0 generation for speech synthesis using a multi-tier approach”, Sun X., in Proc. ICSLP′02, pp. 2077-2080. Moreover, orthogonal polynomials have very useful properties in the solution of mathematical and physical problems. There are two main differences between F0 representation proposed inhere and the representation proposed in the above-mentioned article. The first one is that an orthogonal quadratic approximation is used to replace the exponential approximation. The second one is that the segmental duration is normalized within a range of [−1, 1]. These changes will help improving the goodness of fit in the parametrization.

Legendre polynomials are described as following. Classes of these polynomials are defined over a range t ε[−1, 1] that obey an orthogonality relation in equation 3.

$$\begin{matrix}{\int }_{- 1}^{1} {P}_{m} ( t ) {P}_{n} ( t ) ⅆ t = {δ}_{mn} {c}_{n} & ( 3 ) \\ {δ}_{mn} = \{ \begin{matrix}1 , & when m = n \\ 0 , & when m \neq n\end{matrix} & ( 4 )\end{matrix}$$

Where δₘₙ is the Kronecker delta and cₙ=2/(2n+1). The first three Legendre polynomials are shown in Eq. (5)-(7).

$$\begin{matrix}{p}_{0} ( t ) = 1 & ( 5 ) \\ {p}_{1} ( t ) = t & ( 6 ) \\ {p}_{2} ( t ) = \frac{1}{2} ( 3 {t}^{2} - 1 ) & ( 7 )\end{matrix}$$

Next, for every syllable we define:
T(t)=a₀p₀(t)+a₁p₁(t) (8)
F(t)=a₀p₀(t)+a₁p₁(t)+a₂p₂(t) (9)

Where T(t) represents the underlying F0 target, P(t) represents the surface F0 contour. Coefficient a₀, a₁ and a₂ are Legendre coefficients. a₀ and a₁ represent the intercept and the slope of the underlying F0 target and a₂ is the coefficient of the quadratic approximation part.

Next, at Step 105, an initial parameter prediction model is generated for each of the parameter a₀, a₁ and a₂ in the orthogonal polynomial, respectively. In this embodiment, each of the parameter prediction models is represented by using GLM. The GLM model corresponding to the parameter a₀, a₁ and a₂ is respectively:

$$\begin{matrix}{ì}_{{0}_{i}} = {\hat{a}}_{{0}_{i}} + {e}_{i} = {h}^{- 1} ( {β}_{0} + {\sum }_{j = 1}^{p} {β}_{j} {f}_{j} ( A ) ) + {e}_{i} & ( 10 ) \\ {ì}_{{1}_{i}} = {\hat{a}}_{{1}_{i}} + {e}_{i} = {h}^{- 1} ( {β}_{0} + {\sum }_{j = 1}^{p} {β}_{j} {f}_{j} ( A ) ) + {e}_{i} & ( 11 ) \\ {ì}_{{2}_{i}} = {\hat{a}}_{{2}_{i}} + {e}_{i} = {h}^{- 1} ( {β}_{0} + {\sum }_{j = 1}^{p} {β}_{j} {f}_{j} ( A ) ) + {e}_{i} & ( 12 )\end{matrix}$$

Here, the GLM model (10) for the parameter a₀ will be described firstly.

Specifically, the initial parameter prediction model for the parameter a₀ is generated with a plurality of attributes related to F0 prediction and the combination of these attributes. As mentioned above, there are many attributes related to F0 prediction, they can be roughly divided into attributes of language type and attributes of speech type. Table 1 exemplarily lists some attributes that may be used as attributes related to F0 prediction.

TABLE 1
attributes related to F0 prediction

| Attribute | Description |
|---|---|
| Pho | current phoneme |
| ClosePho | another phoneme in the same syllable |
| PrePho | The neighboring phoneme in the previous syllable |
| NextPho | The neighboring phoneme in the next syllable |
| Tone | Tone of the current syllable |
| PreTone | Tone of the previous syllable |
| NextTone | Tone of the next syllable |
| POS | Part of speech |
| DisNP | Distance to the next pause |
| DisPP | Distance to the previous pause |
| PosWord | Phoneme position in the lexical word |
| ConWordL | Length of the current, previous and next lexical word |
| SNumW | Number of syllables in the lexical word |
| SPosSen | Syllable position in the sentence |
| WNumSen | Number of lexical words in the sentence |
| SpRate | Speaking rate |

In this embodiment, GLM model is used to represent these attributes and attributes combinations. To facilitate explanation, it is assumed that only phone and tone are attributes related to F0 prediction. The form of the initial parameter prediction model for the parameter a₀ is as follows: parameter˜phone+tone+tone*phone, wherein tone*phone means the combination of tone and phone, which is a 2nd order item.

It is appreciated that as the number of attribute increases, there may appear a plurality of 2nd order items, 3rd order items and so on as a result of attribute combination.

In addition, in this embodiment, when the initial parameter prediction model is generated, only a part of attribute combinations may be kept, for instance, only those combinations of up to 2nd order are kept; of course, it is possible to keep combinations of up to 3rd order or to add all attribute combinations into the initial parameter prediction model.

In a word, the initial parameter prediction model includes all independent attributes (1st order items) and at least part of attribute combinations (2nd order items or multi-order items), in which each of the above-mentioned attributes or attribute combinations is included as an item. Thus, the initial parameter prediction model can be automatically generated by using simple rules instead of being set manually based on empiricism as prior art does.

Next, at Step 110, importance of each item is calculated with F-test. As a well known standard statistical method, F-test has been described in detailed in PROBABILITY AND STATISTICS by Sheng Zhou, Xie Shiqian and Pan Shengyi (2000, Second Edition, Higher Education Press), it will not be repeated here.

It should be noted that though F-test is used in this embodiment, other statistical methods such as Chisq-test and so on may also be used.

Next, at Step 115, the item having the lowest score of F-test is deleted from the initial parameter prediction model.

Then, at Step 120, a parameter prediction model is re-generated with the remaining items.

Next, at Step 125, BIC value of the re-generated parameter prediction model is calculated, and the above-mentioned method is used to determine whether the model is an optimal model. Specifically, a training sample of F0 is expanded according to the orthogonal polynomials (9) so that the training sample of each parameter is extracted. In this step, BIC value of the parameter prediction model for the parameter a₀ is calculated according to the training sample of the parameter a₀.

If the determination at Step 125 is “Yes”, then the newly generated parameter prediction model is taken as an optimal model and the process ends at Step 130.

If the determination at Step 125 is “No”, then the process returns to Step 110, the importance of each item of the re-generated model is re-calculated, the unimportant items are deleted (Step 115) and the model is re-generated (Step 120) until an optimal parameter prediction model for the parameter a₀ is obtained.

The parameter prediction models for the parameter a₁ and a₂ are trained according to the same steps as the steps used for the parameter a₀.

Finally, three parameter prediction models for the parameter a₁, a₁ and a₂ are obtained and used with the orthogonal polynomial to form the F0 prediction model.

From the above description it can be seen that the invention constructs simple but reliable F0 prediction modeling frameworks based on the small corpus. A novel F0 parameter prediction model is proposed from target approximation hypothesis to represent a F0 contour.

The present embodiment selects attributes with a Generalized Linear Model (GLM) based F0 modeling method and a F-test and Bayes Information Criterion (BIC) based stepwise regression method. Since the structure of the GLM model of the present embodiment is flexible, it easily adapts to the size of the training database, so that the problem of data sparsity is solved. Further, the important attribute interaction items can be selected automatically with the stepwise regression method.

In addition, in the method for training a F0 prediction model according to one preferred embodiment of the present invention, speaking rate is also adopted as one of a plurality of attributes related to F0 prediction. Since speaking rate is introduced into F0 prediction modeling, a new approach is provided to adjust speaking rate for speech synthesis. Before speech is outputted by a speech synthesis system, the speaking rate may be specified by a user or an application; the speaking rate in the database is also fixed. So the speaking rate is known for both training and testing of the F0 prediction model. The attribute collection of the F0 prediction model not only can introduce speaking rate itself, but also can introduce items that interacts with the speaking rate to improve the precision of F0 prediction. During the process of speech synthesis, speaking rate based F0 prediction can also improve the simple linear lengthening or shortening speaking rate adjusting method. Some researches indicates that the effect of speaking rate on F0 is different from phoneme to phoneme, this also indicates that speaking rate does interact with other attributes.

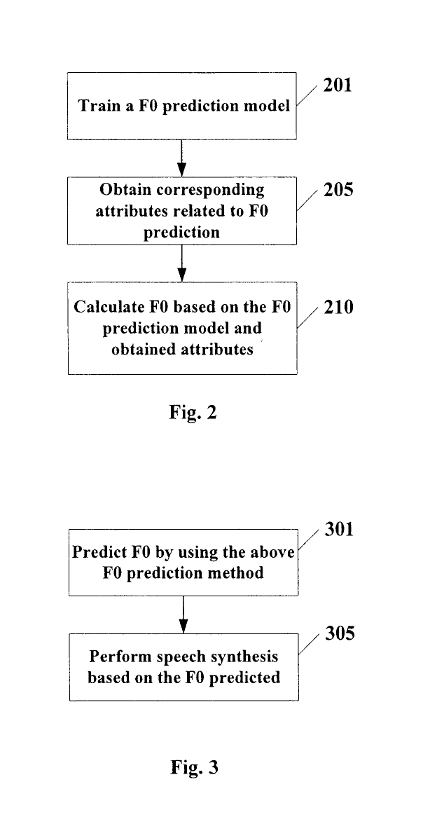

Under the same inventive conception, FIG.2 is a flowchart of the method for F0 prediction according to one embodiment of the present invention. Next, the present embodiment will be described in conjunction with FIG.2. For the same content as the above embodiments, the description of which will be appropriately omitted.

As shown in FIG.2, first at Step 201, a F0 prediction model is trained by using the method for training a F0 prediction model described in the above embodiment.

Next, at Step 205, corresponding values of the plurality of attributes related to F0 prediction are obtained. Specifically, for instance, they can be obtained directly from inputted text, or obtained via grammatical and syntactic analysis. It should be noted that the present embodiment can employ any known or future method to obtain these corresponding attributes and is not limited to a particular manner, and the obtaining manner also corresponds to the selection of the attributes.

Finally, at Step 210, the F0 is calculated based on the trained F0 prediction model and the above obtained attributes.

From the above description it can be seen that since the method for F0 prediction of the present embodiment employs a model trained by the method for training a F0 prediction model of the above embodiments to predict F0, it easily adapts to the size of the training database, so that the problem of data sparsity is solved and the important attribute interaction items can be automatically selected. Therefore, the method for F0 prediction of the present embodiment can more accurately and automatically predict F0.

In addition, in the method for F0 prediction according to one preferred embodiment of the present invention, speaking rate is also adopted as one of a plurality of attributes related to F0 prediction. Thus, by introducing speaking rate into F0 prediction modeling, the attribute collection of a F0 prediction model not only can introduce speaking rate itself, but also can introduce items that interacts with the speaking rate, thereby the precision of F0 prediction can be further improved.

Under the same inventive conception, FIG.3 is a flowchart of the method for speech synthesis according to one embodiment of the present invention. Next, the present embodiment will be described in conjunction with FIG.3. For the same content as the above embodiments, the description of which will be appropriately omitted.

As shown in FIG.3, first at Step 301, F0 is predicted by using the above-mentioned method for F0 prediction described in the above embodiments.

Then, at Step 305, speech synthesis is performed based on the F0 predicted.

From the above description it can be seen that since the method for speech synthesis of the present embodiment employs the method for F0 prediction of the above embodiments to predict F0 and performs speech synthesis based on the predicted result, it easily adapts to the size of the training database, so that the problem of data sparsity is solved and the important attribute interaction items can be automatically selected. Therefore, the method for speech synthesis of the present embodiment can more accurately and automatically perform speech synthesis, and the speech generated will be more reasonable and understandable.

In addition, in the method for speech synthesis according to one preferred embodiment of the present invention, speaking rate is also adopted as one of a plurality of attributes related to F0 prediction. Since speaking rate is introduced into F0 prediction modeling, a new approach is provided to adjust speaking rate for speech synthesis. Before speech is outputted by a speech synthesis system, the speaking rate may be specified by a user or an application; the speaking rate in the database is also fixed. So the speaking rate is known for both training and testing of the F0 prediction model. The attribute collection of a F0 prediction model not only can introduce speaking rate itself, but also can introduce items that interacts with the speaking rate to improve the precision of F0 prediction. During the process of speech synthesis, speaking rate based F0 prediction can also improve the simple linear lengthening or shortening speaking rate adjusting method. Some researches indicates that the effect of speaking rate on F0 is different from phoneme to phoneme, this also indicates that speaking rate does interact with other attributes.

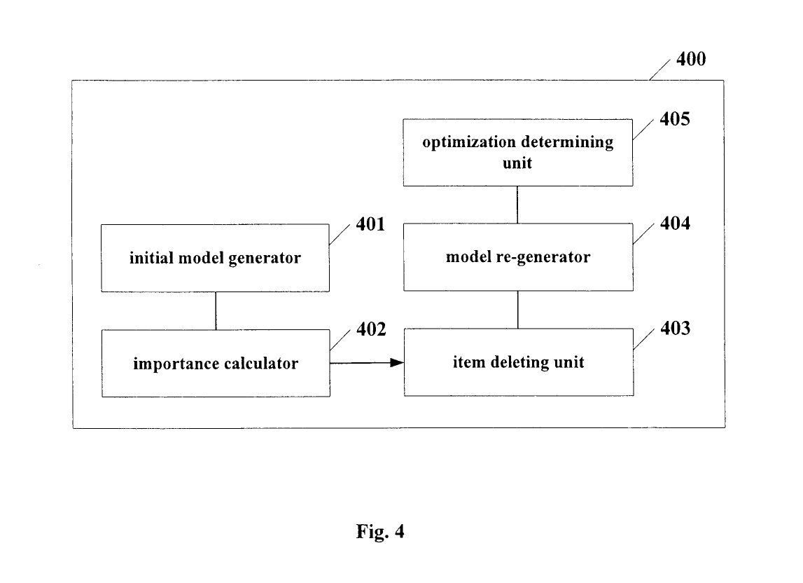

Under the same inventive conception, FIG.4 is a block diagram of the apparatus for training a F0 prediction model according to one embodiment of the present invention. Next, the present embodiment will be described in conjunction with FIG.4. For the same content as the above embodiments, the description of which will be appropriately omitted.

As shown in FIG.4, the apparatus 400 for training a F0 prediction model of the present embodiment comprising: an initial model generator 401 configured to represent F0 with an orthogonal polynomial, and for each parameter of the orthogonal polynomial, generate an initial parameter prediction model with a plurality of attributes related to F0 prediction and at least part of possible attribute combinations of the plurality of attributes, in which each of the plurality of attributes and the attribute combinations is included as an item; an importance calculator 402 configured to calculate importance of each the item in the parameter prediction model; an item deleting unit 403 configured to delete the item having the lowest importance calculated; a model re-generator 404 configured to re-generate a parameter prediction model with the remaining items after the deletion of the item deleting unit; and an optimization determining unit 405 configured to determine whether the parameter prediction model re-generated by the model re-generator is an optimal model; wherein the orthogonal polynomial and all parameter prediction models of the orthogonal polynomial constitute the F0 prediction model.

Same to the above-described embodiments, in this embodiment, F0 is represented with the orthogonal polynomial (9), and a GLM parameter prediction model is built for each of the parameter a₀, a₁ and a₂, respectively. Each parameter prediction model is trained to obtain the optimal parameter prediction model for each of the parameter a₀, a₁ and a₂, respectively. The F0 prediction model is constituted with all parameter prediction models and the orthogonal polynomial together.

Wherein, the plurality of attributes related to F0 prediction comprise: attributes of language type and attributes of speech type, for instance, comprise: any number of attributes selected from the above Table 1.

In addition, the importance calculator 402 calculates the importance of each item with F-test.

In addition, the optimization determining unit 405 determines whether said re-generated parameter prediction model is an optimal model based on Bayes Information Criterion (BIC). Wherein, a training sample of F0 is expanded according to the orthogonal polynomials (9) so that the training sample of each parameter is extracted. For instance, for parameter a₀, BIC value of the parameter prediction model for the parameter a₀ is calculated according to the training sample of the parameter a₀.

In addition, according to one preferred embodiment of the invention, said at least part of attribute combinations comprise all the 2nd order attribute combinations of said plurality of attributes related to F0 prediction.

In addition, according to another preferred embodiment of the invention, said plurality of attributes related to F0 prediction comprise speaking rate.

Here, it should be noted that the apparatus 400 for training a F0 prediction model and its respective components in the present embodiment can be implemented with specifically designed circuits or chips, and also can be implemented by executing corresponding programs on a general computer (processor). Also, the apparatus 400 for training a F0 prediction model in the present embodiment may operationally implement the method for training a F0 prediction model in the above embodiments.

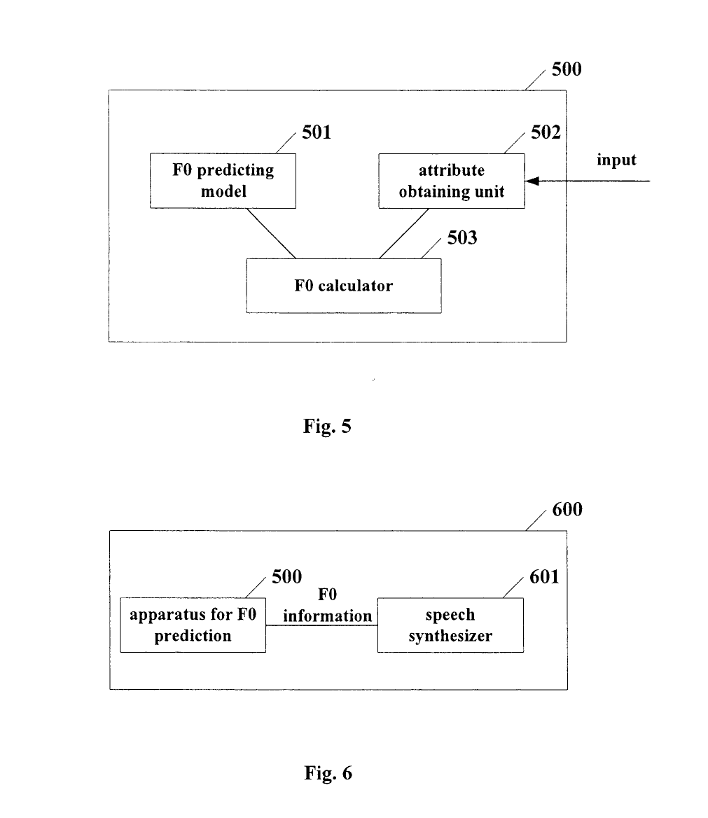

Under the same inventive conception, FIG. 5 is a block diagram of the apparatus for F0 prediction according to one embodiment of the present invention. Next, the present embodiment will be described in conjunction with FIG. 5. For the same content as the above embodiments, the description of which will be appropriately omitted.

As shown in FIG. 5, the apparatus 500 for F0 prediction of the present embodiment comprises: a F0 predicting model 501, which is a F0 prediction model trained by using the above-mentioned method for training a F0 prediction model described in the above embodiments; an attribute obtaining unit 502 configured to obtain corresponding values of the plurality of attributes related to F0 prediction; and a F0 calculator 503 configured to calculate the F0 based on the F0 predicting model 501 and the corresponding values of the plurality of attributes related to F0 prediction obtained by the attribute obtaining unit 502.

Here, for the manner to obtain attributes, as described in the above embodiments, any known or future methods can be used to obtain these corresponding attributes and it is not limited to a particular manner, and the obtaining manner also relates to the selection of attributes. For instance, obtaining the attributes of phone and tone can be performed based on the spelling after text analysis (word segmentation); obtaining the attributes of grammar types can be performed by a grammar analyzer or a syntactic analyzer.

Under the same inventive conception, FIG. 6 is a block diagram of the apparatus for speech synthesis according to one embodiment of the present invention. Next, the present embodiment will be described in conjunction with FIG. 6. For the same content as the above embodiments, the description of which will be appropriately omitted.

As shown in FIG. 6, the apparatus 600 for speech synthesis of the present embodiment comprises: an apparatus 500 for F0 prediction, which can be the apparatus for F0 prediction described in the above embodiment; and a speech synthesizer 601, which may be a prior art speech synthesizer, configured to perform speech synthesis based on the F0s predicted by the above apparatus for F0 prediction.

Here, it should be noted that the apparatus 600 for speech synthesis and its respective components in the present embodiment may be implemented with specifically designed circuits or chips, and also can be implemented by executing corresponding programs on a general computer (processor). Also, the apparatus 600 for speech synthesis of the present embodiment may operationally implement the method for speech synthesis in the above embodiments.

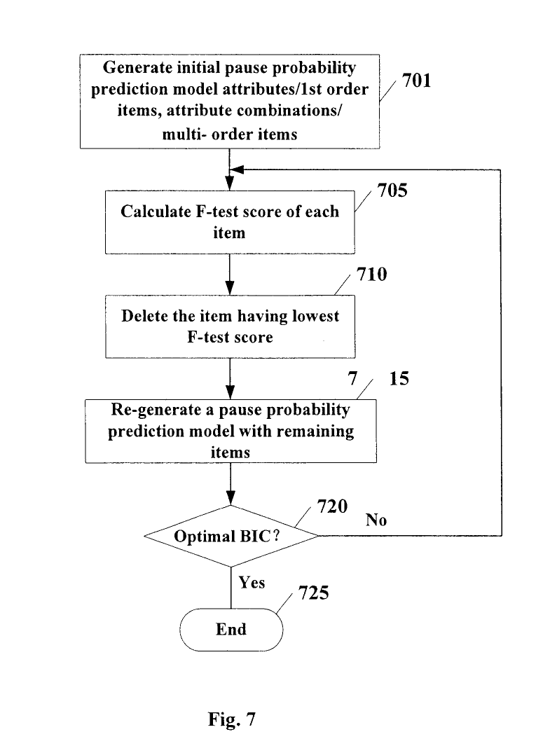

Under the same inventive conception, FIG. 7 is a flowchart of the method for training a pause probability prediction model according to one embodiment of the present invention. The pause probability prediction model trained by the method of this embodiment will be used in the method and apparatus for pause prediction and the method and apparatus for speech synthesis described later in conjunction with other embodiments.

As show in FIG. 7, first at Step 701, an initial pause probability prediction model is generated. Specifically, in this embodiment, although the pause is a binary variable, it is more reasonable to treat the pause as a probability, since the pause varies with a speaker changes styles. The pause occurs independently each time with a certain probability, and the probability obeys Bernoulli distribution.

The GLM model predicts the probability of the pause from attributes by:

$${Pr}_{i} = \hat{P} {r}_{i} + {e}_{i} = {h}^{- 1} ( {β}_{0} + {\sum }_{j = 1}^{p} {β}_{j} {C}_{ij} ) + {e}_{i} 0 < i \leq N \qquad ( 13 )$$

Where Pᵣ is the probability of the pause, h is a link function, N is the number of training samples, i is the index of a sample, C is the attributes, (β₀, β₁, . . . , βₚ) is the vector of regression coefficients, eᵢ is the predicted error and p is the dimension of the regression coefficient vector.

Using different link functions, we can get different exponential family distributions of Pᵣ. When h equals to an identity function, GLM is a linear model. When h equals to a Logit function, GLM is a Logistic GLM model, which are shown in Equation (14) and (15).

$$\begin{matrix}{h}^{- 1} ( z ) = {e}^{z} / ( 1 + {e}^{z} ) & ( 14 ) \\ h ( \hat{P} {r}_{i} ) = logit ( \hat{P} {r}_{i} ) = log [ \hat{P} {r}_{i} / ( 1 - \hat{P} {r}_{i} ) ] = {β}_{0} + {\sum }_{j = 1}^{p} {β}_{j} {C}_{ij} & ( 15 )\end{matrix}$$

Both the plain linear model and Logistic model attempt to estimate the posterior probability Pr(P|C) and have linear classification boundaries. In Logistic GLM, Pr(P|C) is nonlinear function of context C. Logistic model guarantees Pr(P|C) to range from 0 to 1 and to sum up to 1 while the linear model can not. The log ration of posterior probability in Eq. (10), log[\hat{P}rᵢ/(1−\hat{P}rᵢ)] is called log odd. Logistic model satisfies the pause hypothesis of Bernoulli distribution.

Logistic model has been widely used in many statistical fields of classification and regression. Logistic GLM parameters can be estimated by iterative maximum likelihood estimation method. More details can be seen in the reference article “Generalized Linear Models”, McCullagh P. and Nelder J A, Chapman & Hal, London, 1989.

Specifically, the initial pause probability prediction model is generated with a plurality of attributes related to pause prediction and the combination of these attributes. As mentioned above, there are many attributes related to pause prediction, they can be roughly divided into attributes of language type and attributes of speech type. Table 2 exemplarily lists some attributes that may be used as attributes related to pause prediction.

TABLE 2
attributes related to pause prediction

| Attribute | Description |
|---|---|
| Pho | current phoneme |
| ClosePho | another phoneme in the same syllable |
| PrePho | The neighboring phoneme in the previous syllable |
| NextPho | The neighboring phoneme in the next syllable |
| Tone | Tone of the current syllable |
| PreTone | Tone of the previous syllable |
| NextTone | Tone of the next syllable |
| POS | Part of speech |
| DisNP | Distance to the next pause |
| DisPP | Distance to the previous pause |
| PosWord | Phoneme position in the lexical word |
| ConWordL | Length of the current, previous and next lexical word |
| SNumW | Number of syllables in the lexical word |
| SPosSen | Syllable position in the sentence |
| WNumSen | Number of lexical words in the sentence |
| SpRate | Speaking rate |

In this embodiment, GLM model is used to represent these attributes and attributes combinations. To facilitate explanation, it is assumed that only phone and tone are attributes related to pause prediction. The form of the initial pause probability prediction model is as follows: pause probability˜phone+tone+tone*phone, wherein tone*phone means the combination of tone and phone, which is a 2nd order item.

It is appreciated that as the number of attribute increases, there may appear a plurality of 2nd order items, 3rd order items and so on as a result of attribute combination.

In addition, in this embodiment, when the initial pause probability prediction model is generated, only a part of attribute combinations may be kept, for instance, only those combinations of up to 2nd order are kept; of course, it is possible to keep combinations of up to 3rd order or to add all attribute combinations into the initial pause probability prediction model.

In a word, the initial pause probability prediction model includes all independent attributes (1st order items) and at least part of attribute combinations (2nd order items or multi-order items), in which each of the above-mentioned attributes or attribute combinations is included as an item. Thus, the initial pause probability prediction model can be automatically generated by using simple rules instead of being set manually based on empiricism as prior art does.

Next, at Step 705, importance of each item is calculated with F-test. As a well known standard statistical method, F-test has been described in detailed in PROBABILITY AND STATISTICS by Sheng Zhou, Xie Shiqian and Pan Shengyi (2000, Second Edition, Higher Education Press), it will not be repeated here.

It should be noted that though F-test is used in this embodiment, other statistical methods such as Chisq-test and so on may also be used.

Next, at Step 710, the item having the lowest score of F-test is deleted from the initial pause probability prediction model.

Then, at Step 715, a pause probability prediction model is re-generated with the remaining items.

Next, at Step 720, BIC value of the re-generated pause probability prediction model is calculated, and the above-mentioned method is used to determine whether the model is an optimal model.

If the determination at Step 720 is “Yes”, then the newly generated pause probability prediction model is taken as an optimal model and the process ends at Step 725.

If the determination at Step 720 is “No”, then the process returns to Step 705, the importance of each item of the re-generated model is re-calculated, the unimportant items are deleted (Step 710) and a model is re-generated (Step 715) until an optimal pause probability prediction model is obtained.

From the above description it can be seen that the invention constructs simple but reliable pause prediction modeling frameworks based on the small corpus. A novel logistic pause model is proposed from pause Bernoulli hypothesis.

The present embodiment selects attributes with a Generalized Linear Model (GLM) based pause modeling method and a F-test and Bayes Information Criterion (BIC) based stepwise regression method. Since the structure of the GLM model of the present embodiment is flexible, it easily adapts to the size of the training database, so that the problem of data sparsity is solved. Further, the important attribute interaction items can be selected automatically with the stepwise regression method.

In addition, in the method for training a pause probability prediction model according to one preferred embodiment of the present invention, speaking rate is also adopted as one of a plurality of attributes related to pause prediction. Since speaking rate is introduced into pause prediction modeling, a new approach is provided to adjust speaking rate for speech synthesis. Before speech is outputted by a speech synthesis system, the speaking rate may be specified by a user or an application; the speaking rate in the database is also fixed. So the speaking rate is known for both training and testing of the pause probability prediction model. The attribute collection of a pause probability prediction model not only can introduce speaking rate itself, but also can introduce items that interacts with the speaking rate to improve the precision of pause prediction. During the process of speech synthesis, speaking rate based pause prediction can also improve the simple linear lengthening or shortening speaking rate adjusting method. Some researches indicates that the effect of speaking rate on pause is different from phoneme to phoneme, this also indicates that speaking rate does interact with other attributes.

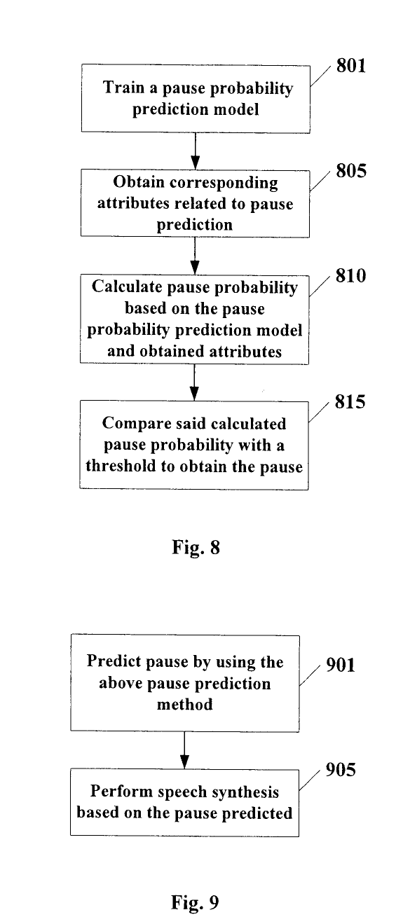

Under the same inventive conception, FIG. 8 is a flowchart of the method for pause prediction according to one embodiment of the present invention. Next, the present embodiment will be described in conjunction with FIG. 8. For the same content as the above embodiments, the description of which will be appropriately omitted.

As shown in FIG. 8, first at Step 801, a pause probability prediction model is trained by using the above-mentioned method for training a pause probability prediction model described in the above embodiment.

Next, at Step 805, corresponding values of the plurality of attributes related to pause prediction are obtained. Specifically, for instance, they can be obtained directly from inputted text, or obtained via grammatical and syntactic analysis. It should be noted that the present embodiment can employ any known or future method to obtain these corresponding attributes and is not limited to a particular manner, and the obtaining manner also corresponds to the selection of the attributes.

Next, at Step 810, the pause probability is calculated based on the trained pause probability prediction model and the above obtained attributes.

Finally, at Step 815, the calculated pause probability is compared with a threshold to obtain the pause. Wherein, the threshold is a number between 0 and 1, such as 0.5, and if the calculated pause probability is larger than the threshold, the pause is 1, otherwise, the pause is 0.

From the above description it can be seen that since the method for pause prediction of the present embodiment employs the model trained by the method for training a pause probability prediction model of the above embodiments to predict the pause, it easily adapts to the size of the training database, so that the problem of data sparsity is solved and the important attribute interaction items can be automatically selected. Therefore, the method for pause prediction of the present embodiment can more accurately and automatically predict the pause.

In addition, in the method for pause prediction according to one preferred embodiment of the present invention, speaking rate is also adopted as one of a plurality of attributes related to pause prediction. Thus, by introducing speaking rate into pause prediction modeling, the attribute collection of the pause probability prediction model not only can introduce speaking rate itself, but also can introduce items that interacts with the speaking rate, thereby the precision of pause prediction can be further improved.

Under the same inventive conception, FIG. 9 is a flowchart of the method for speech synthesis according to one embodiment of the present invention. Next, the present embodiment will be described in conjunction with FIG. 9. For the same content as the above embodiments, the description of which will be appropriately omitted.

As shown in FIG. 9, first at Step 901, a pause is predicted by using the above-mentioned method for pause prediction described in the above embodiments.

Then, at Step 905, speech synthesis is performed based on the pause predicted.

From the above description it can be seen that since the method for speech synthesis of the present embodiment employs the method for pause prediction of the above embodiments to predict pause and performs speech synthesis based on the predicted result, it easily adapts to the size of the training database, so that the problem of data sparsity is solved and the important attribute interaction items can be automatically selected. Therefore, the method for speech synthesis of the present embodiment can more accurately and automatically perform speech synthesis, and the speech generated will be more reasonable and understandable.

In addition, in the method for speech synthesis according to one preferred embodiment of the present invention, speaking rate is also adopted as one of the plurality of attributes related to pause prediction. Since speaking rate is introduced into pause prediction modeling, a new approach is provided to adjust speaking rate for speech synthesis. Before speech is outputted by a speech synthesis system, the speaking rate may be specified by a user or an application; the speaking rate in the database is also fixed. So the speaking rate is known for both training and testing of the pause probability prediction model. The attribute collection of the pause probability prediction model not only can introduce speaking rate itself, but also can introduce items that interacts with the speaking rate to improve the precision of pause prediction. During the process of speech synthesis, speaking rate based pause prediction can also improve the simple linear lengthening or shortening speaking rate adjusting method. Some researches indicate that the effect of speaking rate on pause is different from phoneme to phoneme, this also indicates that speaking rate does interact with other attributes.

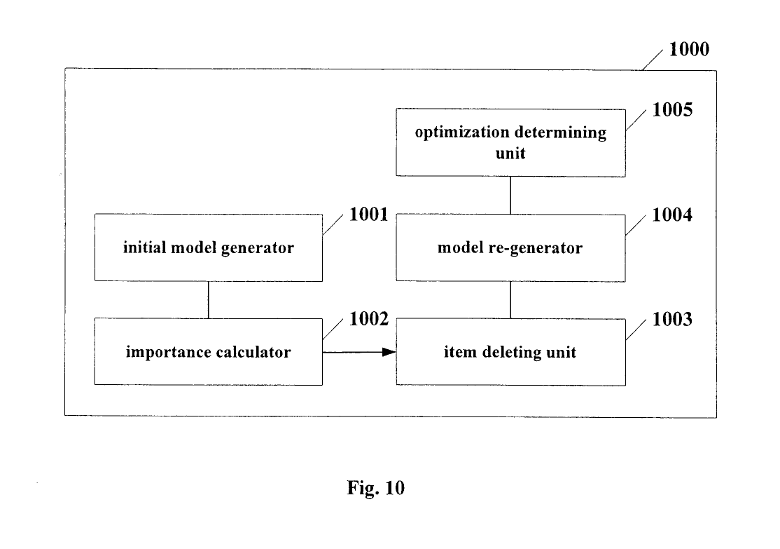

Under the same inventive conception, FIG. 10 is a block diagram of the apparatus for training a pause probability prediction model according to one embodiment of the present invention. Next, the present embodiment will be described in conjunction with FIG. 10. For the same content as the above embodiments, the description of which will be appropriately omitted.

As shown in FIG. 10, the apparatus 1000 for training a pause probability prediction model of the present embodiment comprising: an initial model generator 1001 configured to generate an initial pause probability prediction model with a plurality of attributes related to pause prediction and at least part of possible attribute combinations of the plurality of attributes, in which each of the plurality of attributes and the attribute combinations is included as an item; an importance calculator 1002 configured to calculate importance of each the item in the pause probability prediction model; an item deleting unit 1003 configured to delete the item having the lowest importance calculated; a model re-generator 1004 configured to re-generate a pause probability prediction model with the remaining items after the deletion of the item deleting unit; and an optimization determining unit 1005 configured to determine whether the pause probability prediction model re-generated by the model re-generator is an optimal model.

Same to the above-described embodiments, the plurality of attributes related to pause prediction comprise: attributes of language type and attributes of speech type, for instance, comprise: any number of attributes selected from the above Table 2.

In addition, the importance calculator 1002 calculates the importance of each item with F-test.

In addition, the optimization determining unit 1005 determines whether said re-generated pause probability prediction model is an optimal model based on Bayes Information Criterion (BIC).

In addition, according to one preferred embodiment of the invention, said at least part of attribute combinations comprise all the 2nd order attribute combinations of said plurality of attributes related to pause prediction.

In addition, according to another preferred embodiment of the invention, said plurality of attributes related to pause prediction comprise speaking rate.

Here, it should be noted that the apparatus 1000 for training a pause probability prediction model and its respective components in the present embodiment can be implemented with specifically designed circuits or chips, and also can be implemented by executing corresponding programs on a general computer (processor). Also, the apparatus 1000 for training a pause probability prediction model in the present embodiment may operationally implement the method for training a pause probability prediction model in the above embodiments.

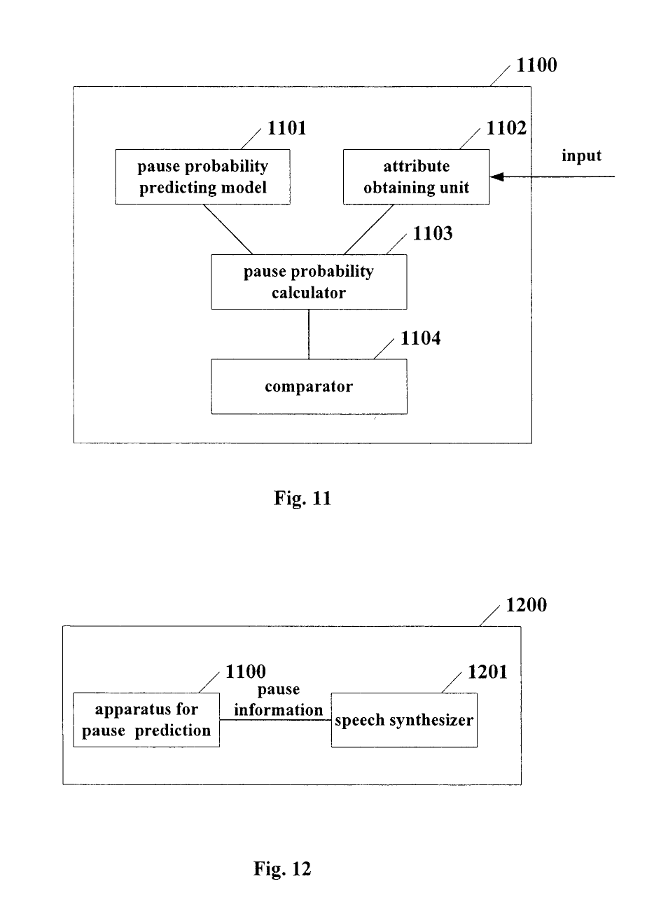

Under the same inventive conception, FIG. 11 is a block diagram of the apparatus for pause prediction according to one embodiment of the present invention. Next, the present embodiment will be described in conjunction with FIG. 11. For the same content as the above embodiments, the description of which will be appropriately omitted.

As shown in FIG. 11, the apparatus 1100 for pause prediction of the present embodiment comprises: a pause probability predicting model 1101, which is the pause probability prediction model trained by using the above-mentioned method for training a pause probability prediction model described in the above embodiments; an attribute obtaining unit 1102 configured to obtain corresponding values of the plurality of attributes related to pause prediction; a pause probability calculator 1103 configured to calculate the pause probability based on the pause probability predicting model 1101 and the corresponding values of the plurality of attributes related to pause prediction obtained by the attribute obtaining unit 1102; and a comparator 1104 configured to compare the calculated pause probability with the threshold to obtain the pause.

Here, for the manner to obtain attributes, as described in the above embodiments, any known or future methods can be used to obtain these corresponding attributes and it is not limited to a particular manner, and the obtaining manner also relates to the selection of attributes. For instance, obtaining the attributes of phone and tone can be performed based on the spelling after text analysis (word segmentation); obtaining the attributes of grammar types can be performed by a grammar analyzer or a syntactic analyzer.

Under the same inventive conception, FIG. 12 is a block diagram of the apparatus for speech synthesis according to one embodiment of the present invention. Next, the present embodiment will be described in conjunction with FIG. 12. For the same content as the above embodiments, the description of which will be appropriately omitted.

As shown in FIG. 12, the apparatus 1200 for speech synthesis of the present embodiment comprises: an apparatus 1100 for pause prediction, which can be the apparatus for pause prediction described in the above embodiment; and a speech synthesizer 1201, which may be a prior art speech synthesizer, configured to perform speech synthesis based on the pauses predicted by the above apparatus for pause prediction.

Here, it should be noted that the apparatus 1200 for speech synthesis and its respective components in the present embodiment may be implemented with specifically designed circuits or chips, and also can be implemented by executing corresponding programs on a general computer (processor). Also, the apparatus 1200 for speech synthesis of the present embodiment may operationally implement the method for speech synthesis in the above embodiments.

Though the method and apparatus for training a F0 prediction model, method and apparatus for F0 prediction, method and apparatus for speech synthesis, and the method and apparatus for training a pause prediction model, method and apparatus for pause prediction, method and apparatus for speech synthesis have been described in details with some exemplary embodiments, these embodiments are not exhaustive. Those skilled in the art may make various variations and modifications within the spirit and scope of the present invention. Therefore, the present invention is not limited to these embodiments; rather, the scope of the present invention is only defined by the appended claims.

1. A method for training an F0 prediction model, comprising:
representing F0 with an orthogonal polynomial;
for each parameter of the orthogonal polynomial,
generating an initial parameter prediction model with a plurality of attributes related to F0 prediction and at least part of possible attribute combinations of said plurality of attributes, in which each of said plurality of attributes and said attribute combinations is included as an item;
calculating importance of each said item in said parameter prediction model;
deleting the item having the lowest importance calculated;
re-generating a parameter prediction model with the remaining items;
determining whether said re-generated parameter prediction model is an optimal model; and
repeating said step of calculating importance and the steps following said step of calculating importance with the newly re-generated parameter prediction model, if said parameter prediction model is determined as not an optimal model;
wherein the orthogonal polynomial and all parameter prediction models of the orthogonal polynomial form the F0 prediction model.

2. The method for training an F0 prediction model according to claim 1, wherein said plurality of attributes related to F0 prediction includes: attributes of language type and speech type.

3. The method for training an F0 prediction model according to claim 1, wherein said plurality of attributes related to F0 prediction include: any selected from current phoneme, another phoneme in the same syllable, neighboring phoneme in the previous syllable, neighboring phoneme in the next syllable, tone of the current syllable, tone of the previous syllable, tone of the next syllable, part of speech, distance to the next pause, distance to the previous pause, phoneme position in the lexical word, length of the current, previous and next lexical word, number of syllables in the lexical word, syllable position in the sentence, and number of lexical words in the sentence.

4. The method for training an F0 prediction model according to claim 1, wherein said parameter prediction model is a Generalized Linear Model (GLM).

5. The method for training an F0 prediction model according to claim 1, wherein said at least part of possible attribute combinations of said plurality of attributes include all 2^{nd} order attribute combinations of said plurality of attributes related to F0 prediction.

6. The method for training an F0 prediction model according to claim 1, wherein said step of calculating importance of each said item in said parameter prediction model comprises: calculating the importance of each said item with F-test.

7. The method for training an F0 prediction model according to claim 1, wherein said step of determining whether said re-generated parameter prediction model is an optimal model comprises: determining whether said re-generated parameter prediction model is an optimal model based on Bayes Information Criterion (BIC).

8. The method for training an F0 prediction model according to claim 7, wherein said step of determining whether said re-generated parameter prediction model is an optimal model comprises:
calculating based on the equation
BIC=Nlog(SSE/N)+plogN
wherein SSE represents sum square of prediction errors and N represents the number of training sample; and
determining said re-generated parameter prediction model as an optimal model, when the BIC is the minimum.

9. The method for training an F0 prediction model according to claim 1, wherein said orthogonal polynomial is a second-order or high-order Legendre orthogonal polynomial.

10. The method for training an F0 prediction model according to claim 9, wherein said Legendre orthogonal polynomial is defined by a formula
F(t)=a₀p₀(t)+a₁p₁(t)+a₂p₂(t)
wherein F(t) represents F0 contour, coefficients a₀, a₁ and a₂ represent said parameters, and t belongs to [−1,1].

11. The method for training an F0 prediction model according to claim 1, wherein said plurality of attributes related to F0 prediction further include speaking rate.

12. A method for F0 prediction, comprising:
training an F0 prediction model using the method for training an F0 prediction model according to any one of claims 1-11;
obtaining corresponding values of said plurality of attributes related to F0 prediction; and
calculating the F0 based on said F0 prediction model and said corresponding values of said plurality of attributes related to F0 prediction.

13. The method for F0 prediction according to claim 12, wherein said plurality of attributes related to F0 prediction include speaking rate.

14. A method for speech synthesis, comprising:
predicting F0 using the method for F0 prediction according to claim 12;
performing speech synthesis based on the F0 predicted.

15. An apparatus for training an F0 prediction model, comprising:
an initial model generator configured to represent F0 with an orthogonal polynomial, and for each parameter of the orthogonal polynomial, generate an initial parameter prediction model with a plurality of attributes related to F0 prediction and at least part of possible attribute combinations of said plurality of attributes, in which each of said plurality of attributes and said attribute combinations is included as an item;
an importance calculator configured to calculate importance of each said item in said parameter prediction model;
an item deleting unit configured to delete the item having the lowest importance calculated;
a model re-generator configured to re-generate a parameter prediction model with the remaining items after the deletion of said item deleting unit; and
an optimization determining unit configured to determine whether said parameter prediction model re-generated by said model re-generator is an optimal model;
wherein the orthogonal polynomial and all parameter prediction models of the orthogonal polynomial constitute the F0 prediction model.

16. The apparatus for training an F0 prediction model according to claim 15, wherein said plurality of attributes related to F0 prediction include: attributes of language type and speech type.

17. The apparatus for training an F0 prediction model according to claim 15, wherein said plurality of attributes related to F0 prediction include: any selected from current phoneme, another phoneme in the same syllable, neighboring phoneme in the previous syllable, neighboring phoneme in the next syllable, tone of the current syllable, tone of the previous syllable, tone of the next syllable, part of speech, distance to the next pause, distance to the previous pause, phoneme position in the lexical word, length of the current, previous and next lexical word, number of syllables in the lexical word, syllable position in the sentence, and number of lexical words in the sentence.

18. The apparatus for training an F0 prediction model according to claim 15, wherein said parameter prediction model is a Generalized Linear Model (GLM).

19. The apparatus for training an F0 prediction model according to claim 15, wherein said at least part of possible attribute combinations of said plurality of attributes include all 2^{nd} order attribute combinations of said plurality of attributes related to F0 prediction.

20. The apparatus for training an F0 prediction model according to claim 15, wherein said importance calculator is configured to calculate the importance of each said item with F-test.

21. The apparatus for training an F0 prediction model according to claim 15, wherein said optimization determining unit is configured to determine whether said re-generated parameter prediction model is an optimal model based on Bayes Information Criterion (BIC).

22. The apparatus for training an F0 prediction model according to claim 15, wherein said orthogonal polynomial is a second-order or high-order Legendre orthogonal polynomial.

23. The apparatus for training an F0 prediction model according to claim 22, wherein said Legendre orthogonal polynomial is defined by a formula
F(t)=a₀p₀(t)+a₁p₁(t)+a₂p₂(t)
wherein F(t) represents F0 contour, coefficients a₀, a₁ and a₂ represent said parameters, and t belongs to [−1,1].

24. The apparatus for training an F0 prediction model according to claim 15, wherein said plurality of attributes related to F0 prediction further include speaking rate.

25. A apparatus for F0 prediction, comprising:
an F0 prediction model that is trained by using the method for training an F0 prediction model according to claim 1;
an attribute obtaining unit configured to obtain corresponding values of said plurality of attributes related to F0 prediction; and
an F0 calculator configured to calculate the F0 based on said F0 prediction model and said corresponding values of said plurality of attributes related to F0 prediction.

26. The apparatus for F0 prediction according to claim 25, wherein said plurality of attributes related to F0 prediction include speaking rate.

27. A apparatus for speech synthesis, comprising:
the apparatus for F0 prediction according to of claim 25; and
said apparatus for speech synthesis is configured to perform speech synthesis based on the F0 predicted by said apparatus for F0 prediction.

28. A method for training a pause probability prediction model, comprising:
generating an initial pause probability prediction model with a plurality of attributes related to pause prediction and at least part of possible attribute combinations of said plurality of attributes, in which each of said plurality of attributes and said attribute combinations is included as an item;
calculating importance of each said item in said pause probability prediction model;
deleting the item having the lowest importance calculated;
re-generating a pause probability prediction model with the remaining items;
determining whether said re-generated pause probability prediction model is an optimal model; and
repeating said step of calculating importance and the steps following said step of calculating importance with the newly re-generated pause probability prediction model, if said pause probability prediction model is determined as not optimal model.

29. The method for training a pause probability prediction model according to claim 28, wherein said plurality of attributes related to pause prediction includes: attributes of language type and speech type.

30. The method for training a pause probability prediction model according to claim 28, wherein said plurality of attributes related to pause prediction include: any selected from current phoneme, another phoneme in the same syllable, neighboring phoneme in the previous syllable, neighboring phoneme in the next syllable, tone of the current syllable, tone of the previous syllable, tone of the next syllable, part of speech, distance to the next pause, distance to the previous pause, phoneme position in the lexical word, length of the current, previous and next lexical word, number of syllables in the lexical word, syllable position in the sentence, and number of lexical words in the sentence.

31. The method for training a pause probability prediction model according to claim 28, wherein said pause probability prediction model is a Generalized Linear Model (GLM).

32. The method for training a pause probability prediction model according to claim 28, wherein said at least part of possible attribute combinations of said plurality of attributes include all 2^{nd} order attribute combinations of said plurality of attributes related to pause prediction.

33. The method for training a pause probability prediction model according to claim 28, wherein said step of calculating importance of each said item in said pause probability prediction model comprises: calculating the importance of each said item with F-test.

34. The method for training a pause probability prediction model according to claim 28, wherein said step of determining whether said re-generated pause probability prediction model is an optimal model comprises: determining whether said re-generated pause probability prediction model is an optimal model based on Bayes Information Criterion (BIC).

35. The method for training a pause probability prediction model according to claim 34, wherein said step of determining whether said re-generated pause probability prediction model is an optimal model comprises:
calculating based on the equation
BIC=Nlog(SSE/N)+plogN
wherein SSE represents sum square of prediction errors and N represents the number of training sample; and
determining said re-generated pause probability prediction model as an optimal model, when the BIC is the minimum.

36. The method for training a pause probability prediction model according to claim 28, wherein the pause probability obeys Bernoulli distribution.

37. The method for training a pause probability prediction model according to claim 1, wherein said plurality of attributes related to pause prediction further include speaking rate.

38. A method for pause prediction, comprising:
training a pause probability prediction model using the method for training a pause probability prediction model according to claim 28;
obtaining corresponding values of said plurality of attributes related to pause prediction;
calculating the pause probability based on said pause probability prediction model and said corresponding values of said plurality of attributes related to pause prediction; and
comparing said calculated pause probability with a threshold to obtain the pause.

39. The method for pause prediction according to claim 38, wherein said threshold is a number between 0 and 1.

40. The method for pause prediction according to claim 39, wherein if said calculated pause probability is larger than said threshold, the pause is 1, otherwise, the pause is 0.

41. The method for pause prediction according to claim 38, wherein said plurality of attributes related to pause prediction include speaking rate.

42. A method for speech synthesis, comprising:
predicting pauses using the method for pause prediction according to claim 38;
performing speech synthesis based on the pauses predicted.

43. An apparatus for training a pause probability prediction model, comprising:
an initial model generator configured to generate an initial pause probability prediction model with a plurality of attributes related to pause prediction and at least part of possible attribute combinations of said plurality of attributes, in which each of said plurality of attributes and said attribute combinations is included as an item;
an importance calculator configured to calculate importance of each said item in said pause probability prediction model;
an item deleting unit configured to delete the item having the lowest importance calculated;
a model re-generator configured to re-generate a pause probability prediction model with the remaining items after the deletion of said item deleting unit; and
an optimization determining unit configured to determine whether said pause probability prediction model re-generated by said model re-generator is an optimal model.

44. The apparatus for training a pause probability prediction model according to claim 43, wherein said plurality of attributes related to pause prediction includes: attributes of language type and speech type.

45. The apparatus for training a pause probability prediction model according to claim 43, wherein said plurality of attributes related to pause prediction include: any selected from current phoneme, another phoneme in the same syllable, neighboring phoneme in the previous syllable, neighboring phoneme in the next syllable, tone of the current syllable, tone of the previous syllable, tone of the next syllable, part of speech, distance to the next pause, distance to the previous pause, phoneme position in the lexical word, length of the current, previous and next lexical word, number of syllables in the lexical word, syllable position in the sentence, and number of lexical words in the sentence.

46. The apparatus for training a pause probability prediction model according to claim 43, wherein said pause probability prediction model is a Generalized Linear Model (GLM).

47. The apparatus for training a pause probability prediction model according to claim 43, wherein said at least part of possible attribute combinations of said plurality of attributes include all 2^{nd} order attribute combinations of said plurality of attributes related to pause prediction.

48. The apparatus for training a pause probability prediction model according to claim 43, wherein said importance calculator is configured to calculate the importance of each said item with F-test.

49. The apparatus for training a pause probability prediction model according to claim 43, wherein said optimization determining unit is configured to determine whether said re-generated pause probability prediction model is an optimal model based on Bayes Information Criterion (BIC).

50. The apparatus for training a pause probability prediction model according to claim 43, wherein the pause probability obeys Bernoulli distribution.

51. The apparatus for training a pause probability prediction model according to claim 43, wherein said plurality of attributes related to pause prediction further include speaking rate.

52. A apparatus for pause prediction, comprising:
a pause probability prediction model that is trained by using the method for training a pause probability prediction model according any one of claims 28-37;
an attribute obtaining unit configured to obtain corresponding values of said plurality of attributes related to pause prediction;
a pause probability calculator configured to calculate the pause probability based on said pause probability prediction model and said corresponding values of said plurality of attributes related to pause prediction; and
a comparator configured to compare said calculated pause probability with a threshold to obtain the pause.

53. The apparatus for pause prediction according to claim 52, wherein said threshold is a number between 0 and 1.

54. The apparatus for pause prediction according to claim 53, wherein if said calculated pause probability is larger than said threshold, the pause is 1, otherwise, the pause is 0.

55. The apparatus for pause prediction according to claim 52, wherein said plurality of attributes related to pause prediction include speaking rate.

56. A apparatus for speech synthesis, comprising:
the apparatus for pause prediction according to claim 52; and
said apparatus for speech synthesis is configured to perform speech synthesis based on the pauses predicted.
